(19) United States
(12) Patent Application Publication
(10) Pub. No.: US 2004/0120687 A1
(43) Pub. Date: Jun. 24, 2004

(54) Christmas tree having fibre optic illumination

(75) Inventor: Chun Chung Fung, Hong Kong (HK)

Correspondence Address: LEYDIG VOIT & MAYER, LTD, 700 THIRTEENTH ST. NW, SUITE 300, WASHINGTON, DC, 20005-3960, US

(73) Assignee: Packway Industries Limited, Kowloon (HK)

(21) Appl. No.: 10/321,837

(22) Filed: Dec. 18, 2002

(51) Int. Cl. G02B 6/00; F21V 7/04

(52) U.S. Cl. 385/147; 362/568

(57) ABSTRACT

A Christmas tree has a base, a trunk formed of two or more interconnected segments, a first of which is supported by the base, a number of branches extending from each segment, two or more light source modules, at least one of which is associated with each segment, and fibre optics extending from each light source to positions upon the branches of the respective segments. The light source modules are mutually interconnected by electric cables Each light source comprises one or more LEDs. The LED(s) of each module is/are mounted upon a PCB that is located within a housing. The fibre optics have ends secured within a socket, which socket is plugged into the respective housing.

### BACKGROUND OF THE INVENTION

The present invention relates to a Christmas trees or other multi-segmented display having fibre optic illumination. More particularly, although not exclusively, the invention relates to a Christmas tree formed of a number of trunk segments wherein each segment has fibre optic decorative illumination and wherein there is a separate light source for the fibre optics of each segment.

It is known to provide fibre optic decorative illumination for Christmas trees. Moreover, it is known to provide a halogen light source in the base of a Christmas tree having a continuous trunk from which a number of branches extend. The fibre optics must pass from the base of the tree to each branch where decorative illumination is desired. Such trees do not lend themselves to easy transportation as do Christmas trees having a trunk formed by interconnected trunk segments. This is due to the full-length of the trunk.

### OBJECT OF THE INVENTION

It is an object of the present invention to overcome or substantially ameliorate the above disadvantage and/or more generally to provide a Christmas tree having a segmented trunk and fibre optic decorative illumination for each tree segment wherein there is an individual light source or sources for the fibre optics of each segment.

### DISCLOSURE OF THE INVENTION

There is disclosed herein a display comprising:

a base,

a centre piece formed of two or more interconnected segments, a first of which is supported by the base,

a plurality of branches extending from each segment,

two or more light source modules, at least one of which is associated with each segment, and

fibre optics extending from each light source to positions upon the branches of the respective segments.

The light sources may or may not be interconnected electrically to facilitate synchronised operation.

Preferably each light source comprises one or more LEDs.

Preferably the LED(s) of each module is/are mounted upon a PCB. Cap on the other hand, other types of light sources may be used and a PCB may or may not be necessary.

Preferably the PCB is located within a housing.

Preferably the fibre optics have ends secured within a socket, which socket is plugged into a said housing.

Preferably the display is in the form of a Christmas tree having a base wherein the centre piece forms a trunk of the Christmas tree, a first said segment of which is supported by the base.

### BRIEF DESCRIPTION OF THE DRAWINGS

A preferred form of the present invention will now be described by way of example with reference to the accompanying drawings, wherein:

FIG. 1 is a schematic segments-exploded elevational view of a Christmas tree and its associated lighting system,

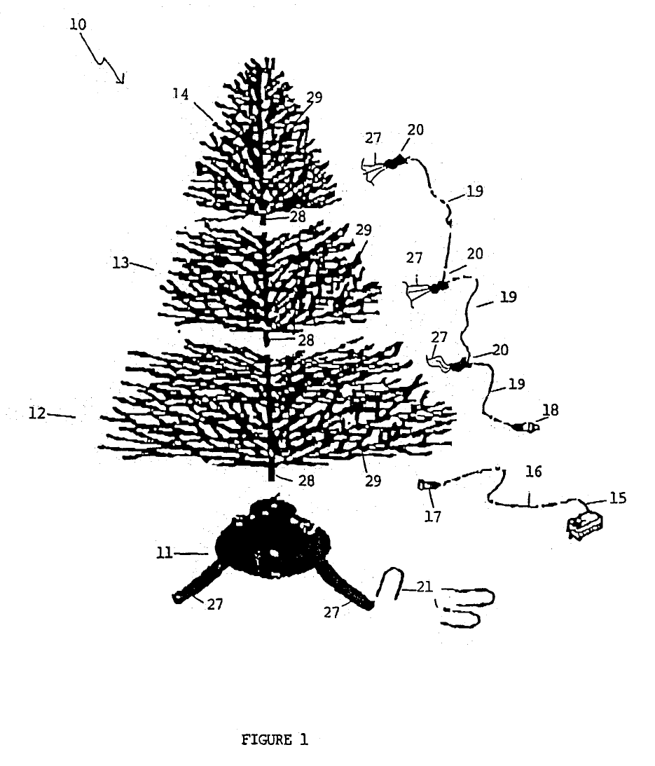

FIG. 2 is a schematic elevational view of a Christmas tree formed of the segments shown in FIG. 1 and parts of the lighting system installed thereon,

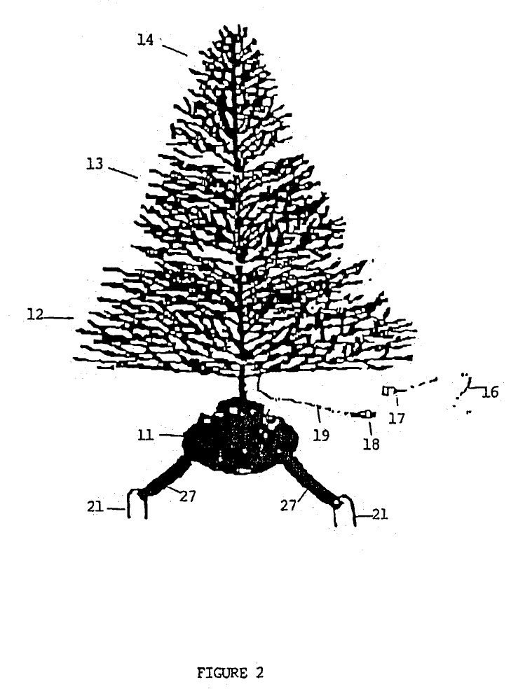

FIG. 3 is a schematic cross-sectional elevational view of a light source module, and

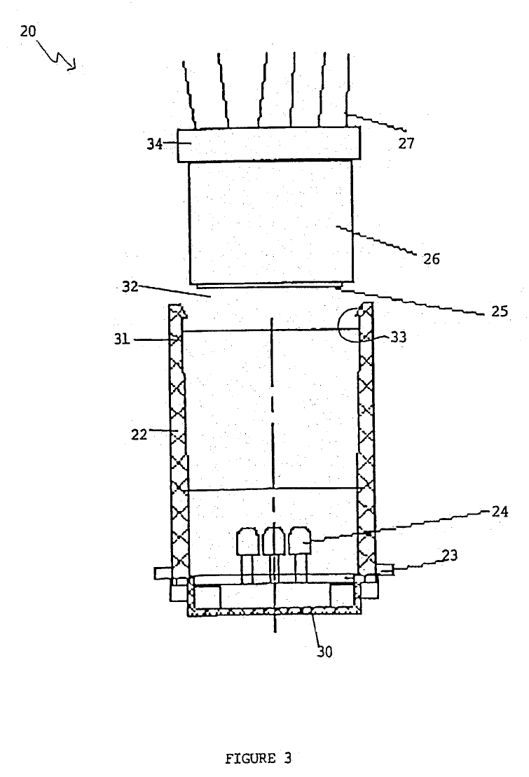

FIG. 4 is a schematic circuit diagram for controlling the lighting effects.

### DESCRIPTION OF THE PREFERRED EMBODIMENT

In the accompanying drawings there is depicted schematically a Christmas tree 10 having a base 11 typically having three legs 27 extending therefrom.

Extending upwardly from and supported by the base 11 are Christmas tree segments 12, 13 and 14. Each segment has a trunk 28 having branches 29 radiating therefrom.

Associated with the tree 10 is a lighting system comprising a transformer plug-pack or battery pack 15 from which an electric cable 16 extends to a socket 17.

A series of lighting modules 20 is interconnected by insulated electric cables 19, the first one of which has a plug 18 to be inserted into the socket 17. From each module 20 there will extend a number of fibre optic cables 27 to be draped over the branches 29 of the respective tree segments 12, 13 and 14. That is, each of the modules 20 serves one tree segment.

Each module 20 comprises a lighting socket 22 in the base of which there is mounted a printed circuit board (PCB) 23 to which one or more light emitting diodes (LEDs) 24 are electrically mounted. The PCB 23 is to be connected to the conductors of the insulated electric cables 19. End portions of the cables might pass through a base plate 30 for this purpose. The housing 22 might be cylindrical in form or otherwise shaped. There is an internal recess 31 adjacent an upper opening 32 of the housing 22. Immediately adjacent the opening 32 is an internal snap-engaging ring 33.

An end portion of a bundle of fibre optic cables 27 is received within an optics plug 26 that is of shape corresponding to that of the housing 22. The optics plug 26 has an annular ridge 34 over which the snap-engaging ring 33 snaps to secure the optics plus 26 within the housing 22 so as to present the ends of the bundled fibre optics cables 27 to the LEDs 24.

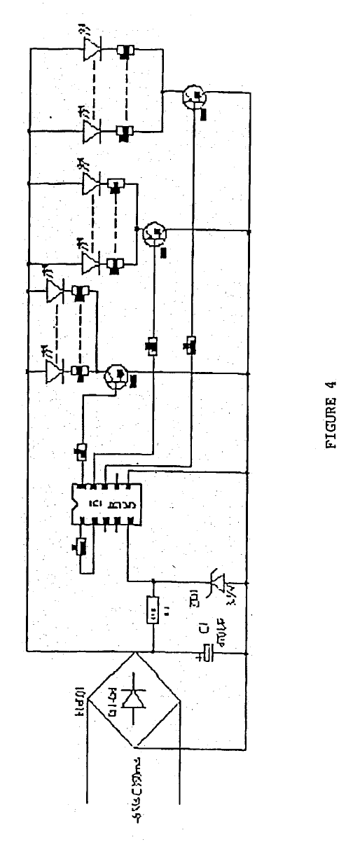

Circuitry as shown for example in FIG. 4 can be provided upon each PCB 23 or within the plug-pack or battery box 15 to effect sequential illumination of the LEDs, a reversal of polarity to change the frequency of emitted light, or otherwise control lighting effects conveyed via the fibre optic cables 27.

It should be appreciated that modifications and alterations obvious to those skilled in the art are not to be considered as beyond the scope of the present invention. For example, instead of using LEDs as the light source, halogen globes or ordinary tungsten globes can be used. However, modern high light-output LEDs are preferred for their efficiency.

1. A display comprising:
centre piece formed of two or more interconnected segments,
a plurality of branches extending from each segment,
two or more light source modules, at least one of which is associated with each segment, and
fibre optics extending from each light source to positions upon the branches of the respective segments.

2. The Display of claim 1 wherein the light source modules are mutually interconnected electrically.

3. The Display of claim 1 wherein each light source comprises one or more LEDs.

4. The Display of claim 3 wherein the LED(s) of each module is/are mounted upon a PCB.

5. The Display of claim 4 wherein each PCB is located within a housing.

6. The Display of claim 5 wherein the fibre optics have ends secured within a socket, which socket is plugged into a said housing.

7. The display of any one of the preceding claims being in the form of a Christmas tree having a base wherein the centre piece forms a trunk of the Christmas tree, a first said segment of which is supported by the base.
